(19) United States
(12) Patent Application Publication
(10) Pub. No.: US 2021/0129134 A1
(43) Pub. Date: May 6, 2021

(54) REFERENCE SLIDE

(71) Applicant: RareCyte, Inc., Seattle, WA (US)

(72) Inventors: Daniel E. CAMPTON, Seattle, WA (US); Ronald C. SEUBERT, Seattle, WA (US)

(21) Appl. No.: 17/087,979

(22) Filed: Nov. 3, 2020

Related U.S. Application Data
(60) Provisional application No. 62/930,362, filed on Nov. 4, 2019.

(51) Int. Cl. B01L 3/00

(52) U.S. Cl. CPC B01L 3/508; B01L 2300/0822

(57) ABSTRACT

A reference slide and methods for making and using the same are considered. The reference slide comprises a reference section, which is an area or location of a substrate comprising one or more reference moieties. The one or more reference moieties, which represent one or more cell lines, comprise one or more distinguishable features. The distinguishable features can be the same as or different than distinguishable features of the sample or target analyte.

### CROSS REFERENCE TO RELATED APPLICATIONS

This application claims the benefit of U.S. Provisional Application No. 62/930,362, filed Nov. 4, 2019, which is herein incorporated by reference in its entirety.

### INCORPORATION BY REFERENCE

All publications and patent applications mentioned in this specification are incorporated herein by reference in their entirety to the same extent as if each individual publication or patent application was specifically and individually indicated to be incorporated by reference.

### FIELD

This disclosure relates generally to process validation, though more specifically, to a reference slide.

### BACKGROUND

Process validation provides a mechanism for the demonstration and documentation that a given process may be consistently and reliably implemented. For example, staining protocols can be validated. As another example, spectral characterizations of detection moieties in given conditions (e.g., pH, temperature, time, etc.) can be validated. As a result, practitioners, researchers, and those implementing various processes continue to seek systems and methods to more efficiently and accurately validate an entire process and/or individual steps of the entire process.

### DESCRIPTION OF THE DRAWINGS

FIGS. 1A-1D show magnified views of example reference sections.

FIGS. 2A-2C show example reference slides.

FIG. 3 shows an example slide with an example functionalized surface.

### DETAILED DESCRIPTION

This disclosure is directed to a reference slide. A reference slide and methods for making and using the same are considered.

In the following descriptions, the term “light” is used to describe various uses and aspects of multiplexing and imaging. The term light is not intended to be limited to describing electromagnetic radiation in the visible portion of the electromagnetic spectrum, but is also intended to describe radiation in the ultraviolet and infrared portions of the electromagnetic spectrum.

In the following descriptions, the term “sample” is used to describe a biological fluid, a biological semi-solid, a biological solid (which can remain solid, such as tissue, or can be liquefied in any appropriate manner), a suspension, a portion of the suspension, a component of the suspension, a cell culture, or the like. For example, for anticoagulated whole blood, the sample is the anticoagulated whole blood (i.e. a suspension), the buffy coat (i.e. a portion of the suspension), a circulating tumor cell (i.e. a component of the suspension) or any other component or components of whole blood. For the sake of convenience, the sample referenced is whole blood, though it should be understood that the method and system described and discussed herein is used with any appropriate sample, such as urine, blood, bone marrow, buffy coat, cystic fluid, ascites fluid, stool, semen, cerebrospinal fluid, nipple aspirate fluid, saliva, amniotic fluid, mucus membrane secretions, aqueous humor, vitreous humor, vomit, vaginal fluid, and any other physiological fluid, tissue, or semi-solid. For example, the sample can be a tissue sample or a material from adipose tissue, an adrenal gland, bone marrow, a breast, a caudate, a cerebellum, a cerebral cortex, a cervix, a uterus, a colon, an endometrium, an esophagus, a fallopian tube, a heart muscle, a hippocampus, a hypothalamus, a kidney, a liver, a lung, a lymph node, an ovary, a pancreas, a pituitary gland, a prostate, a salivary gland, a skeletal muscle, skin, a small intestine, a large intestine, a spleen, a stomach, a testicle, a thyroid gland, or a bladder.

In the following descriptions, the terms “target analyte” or “target material” are used to describe a biological material of interest. It should also be understood that the target analyte can be a fraction of a sample, such as buffy coat, a cell, such as ova, fetal material (such as trophoblasts, nucleated red blood cells, fetal red blood cells, fetal white blood cells, fetal DNA, fetal RNA, or the like), a circulating tumor cell (“CTC”), a circulating endothelial cell, an immune cell (e.g., macrophage, naïve or memory B cells, or naïve or memory T cells), a mesenchymal cell, a stem cell, a vesicle, such as an exosome, a liposome, a protein, a nucleic acid, a biological molecule, a naturally occurring or artificially prepared microscopic unit having an enclosed membrane, parasites (e.g. spirochetes, such as orrelia burgdorferi which cause Lyme disease; malaria-inducing agents), microorganisms, viruses, inflammatory cells, or a portion of a cell culture. For example, the target analyte is a tumor cell from tissue or tissue biopsy, such as adipose tissue, an adrenal gland, bone marrow, a breast, a caudate, a cerebellum, a cerebral cortex, a cervix, a uterus, a colon, an endometrium, an esophagus, a fallopian tube, a heart muscle, a hippocampus, a hypothalamus, a kidney, a liver, a lung, a lymph node, an ovary, a pancreas, a pituitary gland, a prostate, a salivary gland, a skeletal muscle, skin, a small intestine, a large intestine, a spleen, a stomach, a testicle, a thyroid gland, or a bladder.

In the following descriptions, the term “non-target analyte” is used to describe a biological material which is not a target analyte.

In the following descriptions, the term “biomarker” is used to describe a substance that is present on or within the target analyte or target material (i.e. intracellular or extracellular the target analyte; internalized, such as through phagocytosis, within the target analyte; or the like). Biomarkers include, but are not limited to, peptides, proteins, subunits, domains, motifs, epitopes, isoforms, DNA, RNA, or the like. The biomarker can be a target molecule for drug delivery.

The biomarker or biomarkers include, but are not limited to: 17-IA, 4-1BB, 4Dc, 6-keto-PGF1a, 8-iso-PGF2a, 8-oxo-dG, A1 Adenosine Receptor, A33, ACE, ACE-2, Activin, Activin A, Activin AB, Activin B, Activin C, Activin RIA, Activin RIA ALK-2, Activin RIB ALK-4, Activin RIIA, Activin RIIB, ADAM, ADAM10, ADAM12, ADAM15, ADAM17/TACE, ADAMS, ADAMS, ADAMTS, ADAMTS4, ADAMTS5, Addressins, aFGF, ALCAM, ALK, ALK-1, ALK-7, alpha-1-antitrypsin, alpha-V/beta-1 antagonist, ANG, Ang, APAF-1, APE, APJ, APP, APRIL, AR, ARC, ART, Artemin, anti-Id, ASPARTIC, Atrial natriuretic factor, av/b3 integrin, Axl, b2M, B7-1, B7-2, B7-H, B-lymphocyte Stimulator (BlyS), BACE, BACE-1, Bad, BAFF, BAFF-R, Bag-1, BAK, Bax, BCA-1, BCAM, Bcl, BCMA, BDNF, b-ECGF, bFGF, BID, Bik, BIM, BLC, BL-CAM, BLK, BMP, BMP-2 BMP-2a, BMP-3 Osteogenin, BMP-4 BMP-2b, BMP-5, BMP-6 Vgr-1, BMP-7 (OP-1), BMP-8 (BMP-8a, OP-2), BMPR, BMPR-IA (ALK-3), BMPR-IB (ALK-6), BRK-2, RPK-1, BMPR-II (BRK-3), BMPs, b-NGF, BOK, Bombesin, Bone-derived neurotrophic factor, BPDE, BPDE-DNA, BTC, complement factor 3 (C3), C3a, C4, C5, C5a, C10, CA125, CAD-8, Calcitonin, cAMP, carcinoembryonic antigen (CEA), carcinoma-associated antigen, Cathepsin A, Cathepsin B, Cathepsin C/DPPI, Cathepsin D, Cathepsin E, Cathepsin H, Cathepsin L, Cathepsin O, Cathepsin S, Cathepsin V, Cathepsin X/Z/P, CBL, CCI, CCK2, CCL, CCL1, CCL11, CCL12, CCL13, CCL14, CCL15, CCL16, CCL17, CCL18, CCL19, CCL2, CCL20, CCL21, CCL22, CCL23, CCL24, CCL25, CCL26, CCL27, CCL28, CCL3, CCL4, CCL5, CCL6, CCL7, CCL8, CCL9/10, CCR, CCR1, CCR10, CCR10, CCR2, CCR3, CCR4, CCR5, CCR6, CCR7, CCR8, CCR9, CD1, CD2, CD3, CD3E, CD4, CD5, CD6, CD7, CD8, CD10, CD11a, CD11b, CD11c, CD13, CD14, CD15, CD16, CD18, CD19, CD20, CD21, CD22, CD23, CD25, CD27L, CD28, CD29, CD30, CD30L, CD31, CD32, CD33 (p67 proteins), CD34, CD38, CD40, CD40L, CD44, CD45, CD46, CD49a, CD52, CD54, CD55, CD56, CD61, CD64, CD66b, CD66e, CD74, CD80 (B7-1), CD89, CD95, CD105, CD123, CD137, CD138, CD140a, CD144, CD146, CD147, CD148, CD152, CD164, CEACAM5, CFTR, cGMP, CINC, Clostridium botulinum toxin, Clostridium peffringens toxin, CKb8-1, CLC, CMV, CMV UL, CNTF, CNTN-1, COX, C-Ret, CRG-2, CT-1, CTACK, CTGF, CTLA-4, CX3CL1, CX3CR1, CXCL, CXCL1, CXCL2, CXCL3, CXCL4, CXCL5, CXCL6, CXCL7, CXCL8, CXCL9, CXCL10, CXCL11, CXCL12, CXCL13, CXCL14, CXCL15, CXCL16, CXCR, CXCR1, CXCR2, CXCR3, CXCR4, CXCR5, CXCR6, cytokeratin, DAN, DCC, DcR3, DC-SIGN, Decay accelerating factor, des(1-3)-IGF-I (brain IGF-1), Dhh, digoxin, DLL3, DNAM-1, Dnase, Dpp, DPPIV/CD26, Dtk, EGAD, EDA, EDA-A1, EDA-A2, EDAR, EGF, EGFR (ErbB-1), EMA, EMMPRIN, ENA, endothelin receptor, ER, Enkephalinase, eNOS, Eot, eotaxin1, EpCAM, Ephrin B2/EphB4, EP0, ERCC, E-selectin, ET-1, Factor IIa, Factor VII, Factor VIIIc, Factor IX, fibroblast activation protein (FAP), fibronectin, Fas, FcR1, FEN-1, Ferritin, FGF, FGF-19, FGF-2, FGF3, FGF-8, FGFR, FGFR-3, Fibrin, FL, FLIP, Flt-3, Flt-4, Follicle stimulating hormone, Fractalkine, FZD1, FZD2, FZD3, FZD4, FZD5, FZD6, FZD7, FZD8, FZD9, FZD10, G250, Gas 6, GCP-2, GCSF, GD2, GD3, GDF, GDF-1, GDF-3 (Vgr-2), GDF-5 (BMP-14, CDMP-1), GDF-6 (BMP-13, CDMP-2), GDF-7 (BMP-12, CDMP-3), GDF-8 (Myostatin), GDF-9, GDF-15 (MIC-1), GDNF, GDNF, GFAP, GFRa-1, GFR-alpha1, GFR-alpha2, GFR-alpha3, GITR, Glucagon, Glut 4, glycoprotein IIb/IIIa (GP IIb/IIIa), GM-CSF, gp130, gp72, GRO, Growth hormone releasing factor, Hapten (NP-cap or NIP-cap), HB-EGF, HCC, HCMV gB envelope glycoprotein, HCMV) gH envelope glycoprotein, HCMV UL, Hemopoietic growth factor (HGF), Hep B gp120, heparanase, Her2, Her2/neu (ErbB-2), Her3 (ErbB-3), Her4 (ErbB-4), herpes simplex virus (HSV) gB glycoprotein, HSV gD glycoprotein, HGFA, High molecular weight melanoma-associated antigen (HMW-MAA), HIV gp120, HIV IIIB gp120 V3 loop, HLA, HLA-DR, HM1.24, HMFG PEM, HRG, Hrk, human cardiac myosin, human cytomegalovirus (HCMV), human growth hormone (HGH), HVEM, 1-309, IAP, ICAM, ICAM-1, ICAM-3, ICE, ICOS, IFNg, Ig, IgA receptor, IgE, IGF, IGF binding proteins, IGF-1R, IGFBP, IGF-1, IGF-II, IL, IL-1, IL-1R, IL-2, IL-2R, IL-4, IL-4R, IL-5, IL-5R, IL-6, IL-6R, IL-8, IL-9, IL-10, IL-12, IL-13, IL-15, IL-18, IL-18R, IL-23, interferon (INF)-alpha, INF-beta, INF-gamma, Inhibin, iNOS, Insulin A-chain, Insulin B-chain, Insulin-like growth factor 1, integrin alpha2, integrin alpha3, integrin alpha4, integrin alpha4/betal, integrin alpha4/beta7, integrin alpha5 (alphaV), integrin alpha5/beta1, integrin alpha5/beta3, integrin alpha6, integrin beta1, integrin beta2, interferon gamma, IP-10, I-TAC, JE, Kallikrein 2, Kallikrein 5, Kallikrein 6, Kallikrein 11, Kallikrein 12, Kallikrein 14, Kallikrein 15, Kallikrein L1, Kallikrein L2, Kallikrein L3, Kallikrein L4, KC, KDR, Keratinocyte Growth Factor (KGF), Ki67, laminin 5, LAMP, LAP, LAP (TGF-1), Latent TGF-1, Latent TGF-1 bp1, LBP, LDGF, LECT2, Lefty, Lewis-Y antigen, Lewis-Y related antigen, LFA-1, LFA-3, Lfo, LIF, LIGHT, lipoproteins, LIX, LKN, Lptn, L-Selectin, LT-a, LT-b, LTB4, LTBP-1, Lung surfactant, Luteinizing hormone, Lymphotoxin Beta Receptor, Mac-1, MAdCAM, MAG, MAP2, MARC, MCAM, MCAM, MCK-2, MCP, M-CSF, MDC, Mer, METALLOPROTEASES, MGDF receptor, MGMT, MHC (HLA-DR), MIF, MIG, MIP, MIP-1-alpha, MK, MMAC1, MMP, MMP-1, MMP-10, MMP-11, MMP-12, MMP-13, MMP-14, MMP-15, MMP-2, MMP-24, MMP-3, MMP-7, MMP-8, MMP-9, MPIF, Mpo, M30, MSK, MSP, mucin (Muc1), MUC18, Muellerian-inhibitin substance, Mug, MuSK, NAIP, NAP, NCAD, N-Cadherin, NCA 90, NCAM, NCAM, Neprilysin, Neurotrophin-3,-4, or -6, Neurturin, Neuronal growth factor (NGF), NGFR, NGF-beta, nNOS, NO, NOS, Npn, NRG-3, NT, NTN, OB, OGG1, OPG, OPN, OSM, OX40L, OX40R, p150, p95, PADPr, Parathyroid hormone, PARC, PARP, PBR, PBSF, PCAD, P-Cadherin, PCNA, PDGF, PDGF, PDK-1, PECAM, PEM, PF4, PGE, PGF, PGI2, PGD2, PIN, PLA2, placental alkaline phosphatase (PLAP), PIGF, PLP, PP14, Proinsulin, Prorelaxin, Protein C, PR, PS, PSA, PSCA, prostate specific membrane antigen (PSMA), PTEN, PTHrp, Ptk, PTN, R51, RANK, RANKL, RANTES, RANTES, Relaxin A-chain, Relaxin B-chain, renin, respiratory syncytial virus (RSV) F, RSV Fgp, Ret, Rheumatoid factors, RLIP76, RPA2, RSK, 5100, SCF/KL, SDF-1, SERINE, Serum albumin, sFRP-3, Shh, SIGIRR, SK-1, SLAM, SLPI, SMAC, SMDF, SMOH, SOD, SPARC, Stat, STEAP, STEAP-II, TACE, TACI, TAG-72 (tumor-associated glycoprotein-72), TARC, TCA-3, T-cell receptors (e.g., T-cell receptor alpha/beta), TdT, TECK, TEM1, TEM5, TEM7, TEM8, TERT, testicular PLAP-like alkaline phosphatase, TfR, TGF, TGF-alpha, TGF-beta, TGF-beta Pan Specific, TGF-beta RI (ALK-5), TGF-beta R11, TGF-beta RIIb, TGF-beta RIII, TGF-betal, TGF-beta2, TGF-beta3, TGF-beta4, TGF-beta5, Thrombin, Thymus Ck-1, Thyroid stimulating hormone, Tie, TIMP, TIQ, Tissue Factor, TMEFF2, Tmpo, TMPRSS2, TNF, TNF-alpha, TNF-alpha beta, TNF-beta2, TNFα, TNF-RI, TNF-RII, TNFRSF10A (TRAIL R1 Apo-2, DR4), TNFRSF10B (TRAIL R2DR5, KILLER, TRICK-2A, TRICK-B), TNFRSF10C (TRAIL R3DcR1, LIT, TRID), TNFRSF10D (TRAIL R4DcR2, TRUNDD), TNFRSF11A (RANK ODF R, TRANCE R), TNFRSF11B (OPG OCIF, TR1), TNFRSF12 (TWEAK R FN14), TNFRSF13B (TACI), TNFRSF13C (BAFF R), TNFRSF14 (HVEM ATAR, HveA, LIGHT R, TR2), TNFRSF16 (NGFR p75NTR), TNFRSF17 (BCMA), TNFRSF18 (GITRAITR), TNFRSF19 (TROY TAJ, TRADE), TNFRSF19L (RELT), TNFRSF1A (TNF R1CD120a, p55-60), TNFRSF1B (TNF RII CD120b, p′75-80), TNFRSF26 (TNFRH3), TNFRSF3 (LTbR TNF RIII, TNFC R), TNFRSF4 (0X40 ACT35, TXGP1 R), TNFRSF5 (CD40 p50), TNFRSF6 (Fas Apo-1, APT1, CD95), TNFRSF6B (DcR3M68, TR6), TNFRSF7 (CD27), TNFRSF8 (CD30), TNFRSF9 (4-1 BB CD137, ILA), TNFRSF21 (DR6), TNFRSF22 (DCTRAIL R2TNFRH2), TNFRST23 (DCTRAIL R1 TNFRH1), TNFRSF25 (DR3Apo-3, LARD, TR-3, TRAMP, WSL-1), TNFSF10 (TRAIL Apo-2 Ligand, TL2), TNFSF11 (TRANCE/RANK Ligand ODF, OPG Ligand), TNFSF12 (TWEAK Apo-3 Ligand, DR3Ligand), TNFSF13 (APRIL TALL2), TNFSF13B (BAFF BLYS, TALL1, THANK, TNFSF20), TNFSF14 (LIGHT HVEM Ligand, LTg), TNFSF15 (TL1A/VEGI), TNFSF18 (GITR Ligand AITR Ligand, TL6), TNFSF1A (TNF-a Conectin, DIF, TNFSF2), TNFSF1 B (TNF-b LTa, TNFSF1), TNFSF3 (LTb TNFC, p33), TNFSF4 (0X40 Ligand gp34, TXGP1), TNFSF5 (CD40 Ligand CD154, gp39, HIGM1, IMD3, TRAP), TNFSF6 (Fas Ligand Apo-1 Ligand, APT1 Ligand), TNFSF7 (CD27 Ligand CD70), TNFSF8 (CD30 Ligand CD153), TNFSF9 (4-1BB Ligand CD137 Ligand), TP-1, t-PA, Tpo, TRAIL, TRAIL R, TRAIL-R1, TRAIL-R2, TRANCE, transferring receptor, TRF, Trk, TROP-2, TSG, TSLP, tumor-associated antigen CA 125, tumor-associated antigen expressing Lewis Y related carbohydrate, TWEAK, TXB2, Ung, uPAR, uPAR-1, Urokinase, VCAM, VCAM-1, VECAD, VE-Cadherin, VE-cadherin-2, VEFGR-1 (fit-1), VEGF, VEGFR, VEGFR-3 (flt-4), VEGI, VIM, Vimentin, Viral antigens, VLA, VLA-1, VLA-4, VNR integrin, von Willebrands factor, WIF-1, WNT1, WNT2, WNT2B/13, WNT3, WNT3A, WNT4, WNT5A, WNT5B, WNT6, WNT7A, WNT7B, WNT8A, WNT8B, WNT9A, WNT9A, WNT9B, WNT10A, WNT10B, WNT11, WNT16, XCL1, XCL2, XCR1, XCR1, XEDAR, XIAP, XPD, and receptors for hormones and growth factors. The biomarkers include proteins, subunits, domains, motifs, isoforms, and/or epitopes of the biomarkers.

In the following descriptions, the term “affinity molecule” is used to describe any molecule that is capable of binding or interacting with a biomarker or a reference moiety. The interaction or binding can be covalent or non-covalent. The affinity molecule includes, but is not limited to, an antibody, a hapten, a protein, an aptamer, an oligonucleotide, a polynucleotide, or any appropriate molecule for interacting with or binding to the biomarker.

In the following descriptions, the term “reference moiety” is used to describe any molecule, substance, or object that represents a target analyte or a component of a target analyte. The reference moiety includes, but is not limited to, a non-naturally occurring surrogate, a cell, an antibody, a hapten, a protein, a peptide, an aptamer, an oligonucleotide, a polynucleotide, a bead (e.g., composed of a polymer, a metal, glass, ceramic, or the like), a combination thereof, or the like. The reference moiety can comprise any appropriate molecule for interacting with or binding to an affinity molecule. The reference moiety can be functionalized.

In the following descriptions, the term “reference line” is used to describe one or more reference moieties which represent a portion (e.g., cell, protein, biomarker, or the like) of a sample having one or common features, traits, or characteristics. The portion of the sample being represented can have one or more differences between the individual members (e.g., reference moieties), such as biomarker or protein expression.

In the following descriptions, the term “distinguishable feature” is used to describe an attribute, characteristic, aspect, or the like about one or more reference moieties, one or more reference lines, and/or one or more reference sections that differentiates the one or more reference moieties, one or more reference lines, or the one or more reference sections from a sample or target analyte. For example, the distinguishable feature can be one or more of location on the slide (e.g., known location and/or recorded location), size (i.e., size of the reference moiety compared to the size of the sample or target analyte—e.g., can be larger or smaller), shape (i.e., shape of the reference moiety compared to the shape of the sample or target analyte), pre-labeled, labeled in one channel not used by the sample or target analyte, labeled in the channel used by the sample or target analyte, light modality (e.g., transmitted light when sample or target analyte uses fluorescent light; or, fluorescent light when sample or target analyte uses transmitted light), specific marker, autofluorescence, pattern/formation (e.g., random, circle, triangle, square, rectangle, parallelogram, rhombus, pentagon, line, reference moiety arrangements within the pattern/formation,), or the like.

In the following descriptions, the term “detection moiety” is used to describe a compound or substance which provides a signal for detection, thereby indicating the presence of another compound or substance, an analyte, or the like within a sample or specimen. The detection moiety can be fluorescent, such as a fluorescent probe, or chromogenic, such as a chromogenic dye. The fluorescent probe can be a reactive dye, an organic dye, a fluorescent protein, a quantum dot, non-protein organic molecules, a nanoparticle (e.g., nanodiamond), a fluorescent nanoparticle, an encapsulated fluorescent probe, a phosphor-integrated dot, or the like. The detection moiety can be used as a tracer, as a label for certain structures, as a label for biomarkers, or the like. The detection moiety can be distributed or can label the appropriate structure or biomarkers in manners including, but not limited to, uptake, selective uptake, diffusion, and attachment to a linking molecule.

The chromogenic dye, which can be used with various enzyme labels (e.g. horseradish peroxidase and alkaline phosphate), includes, but is not limited to, 3,3′-Diaminobenzidine (DAB), 3-Amino-9-Ethylcarbazole (AEC), 4-Chloro-1-Naphtol (CN), P-Phenylenediamine Dihydrochloride/pyrocatechol (Hanker-Yates reagent), Fast Red TR, New Fuchsin, Fast Blue BB, or the like. Fluorescent probes include, but are not limited to 1,5 IAEDANS; 1,8-ANS; 4-Methylumbelliferone; 5-carboxy-2,7-dichlorofluorescein; 5-Carboxyfluorescein (5-FAM); 5-Carboxynapthofluorescein; 5-Carboxytetramethylrhodamine (5-TAMRA); 5-FAM (5-Carboxyfluorescein); 5-HAT (Hydroxy Tryptamine); 5-Hydroxy Tryptamine (HAT); 5-ROX (carboxy-X-rhodamine); 5-TAMRA (5-Carboxytetramethylrhodamine); 6-Carboxyrhodamine 6G; 6-CR 6G; 6-JOE; 7-Amino-4-methylcoumarin; 7-Aminoactinomycin D (7-AAD); 7-Hydroxy-4-methylcoumarin; 9-Amino-6-chloro-2-methoxyacridine; AB Q; Acid Fuchsin; ACMA (9-Amino-6-chloro-2-methoxyacridine); Acridine Orange; Acridine Red; Acridine Yellow; Acriflavin; Acriflavin Feulgen SITSA; Aequorin (Photoprotein); AutoFluorescent Protein; Alexa Fluor 350™; Alexa Fluor 430™; Alexa Fluor 488™; Alexa Fluor 532™; Alexa Fluor 546™; Alexa Fluor 568™; Alexa Fluor 594™; Alexa Fluor 633™; Alexa Fluor 647™; Alexa Fluor 660™; Alexa Fluor 680™; Alizarin Complexon; Alizarin Red; Allophycocyanin (APC); AMC; AMCA-S; AMCA (Aminomethylcoumarin); AMCA-X; Aminoactinomycin D; Aminocoumarin; Aminomethylcoumarin (AMCA); Anilin Blue; Anthrocyl stearate; APC (Allophycocyanin); APC-Cy7; APTRA-BTC; APTS; Astrazon Brilliant Red 4G; Astrazon Orange R; Astrazon Red 6B; Astrazon Yellow 7 GLL; Atabrine; ATTO-TAGTM CBQCA; ATTO-TAGTM FQ; Auramine; Aurophosphine G; Aurophosphine; BAO 9(Bisaminophenyloxadiazole); BCECF (high pH); BCECF (low pH); Berberine Sulphate; Beta Lactamase; BFP blue shifted GFP (Y66H; Blue Fluorescent Protein); BFP/GFP FRET; Bimane; Bisbenzamide; Bisbenzimide (Hoechst); bis-BTC; Blancophor FFG; Blancophor SV; BOBO™-1; BOBO™-3; Bodipy 492/515; Bodipy 493/503; Bodipy 500/510; Bodipy 505/515; Bodipy 530/550; Bodipy 542/563; Bodipy 558/568; Bodipy 564/570; Bodipy 576/589; Bodipy 581/591; Bodipy 630/650-X; Bodipy 650/665-X; Bodipy 665/676; Bodipy F1; Bodipy FL ATP; Bodipy F1-Ceramide; Bodipy R6G SE; Bodipy TMR; Bodipy TMR-X conjugate; Bodipy TMR-X, SE; Bodipy TR; Bodipy TR ATP; Bodipy TR-X SE; BO-PRO™-1; BO-PRO™-3; Brilliant Sulphoflavin FF; Brilliant Violet 421; Brilliant Violet 510; Brilliant Violet 605; Brilliant Violet 650; Brilliant Violet 711; Brilliant Violet 786; BTC; BTC-5N; Calcein; Calcein Blue; Calcium Crimson™; Calcium Green; Calcium Green-1; Calcium Green-2; Calcium Green-5N; Calcium Green-C18; Calcium Orange; Calcofluor White; Carboxy-X-hodamine (5-ROX); Cascade Blue™; Cascade Yellow; Catecholamine; CCF2 (GeneBlazer); CFDA; CFP (Cyan Fluorescent Protein); CF405S; CF488A;; CF 543; CF 647; CF 750;; CF 780; FP/YFP FRET; Chlorophyll; Chromomycin A; Chromomycin A; CL-NERF; CMFDA; Coelenterazine; Coelenterazine cp; Coelenterazine f; Coelenterazine fcp; Coelenterazine h; Coelenterazine hcp; Coelenterazine ip; Coelenterazine n; Coelenterazine O; Coumarin Phalloidin; C-phycocyanine; CPM Methylcoumarin; CTC; CTC Formazan; Cy2™; Cy3.1 8; Cy3.5™; Cy3™; Cy5.1 8; Cy5.5™; CyS™; Cy7™; Cyan GFP; cyclic AMP Fluorosensor (FiCRhR); CyQuant Cell Proliferation Assay; Dabcyl; Dansyl; Dansyl Amine; Dansyl Cadaverine; Dansyl Chloride; Dansyl DHPE; DAPI; Dapoxyl; Dapoxyl 2; Dapoxyl 3; DCFDA; DCFH (Dichlorodihydrofluorescein Diacetate); DDAO; DHR (Dihydorhodamine 123); Di-4-ANEPPS; Di-8-ANEPPS; DiA (4-Di-16-ASP); Dichlorodihydrofluorescein Diacetate (DCFH); DiD-Lipophilic Tracer; DiD (DiIC18(5)); DIDS; Dihydorhodamine 123 (DHR); DiI (DiIC18(3)); Dinitrophenol; DiO (DiOC18(3)); DiR; DiR (DiIC18(7)); DM-NERF (high pH); DNP; Dopamine; DsRed; DTAF; DY-630-NHS; DY-635-NHS; EBFP (Enhanced Blue Fluorescent Protein); ECFP (Enhanced Cyan Fluorescent Protein); EGFP (Enhanced Green Fluorescent Protein); ELF 97; Eosin; ER-Tracker™ Green; ER-Tracker™ Red; ER-Tracker™ Blue-White DPX; Erythrosin; Erythrosin ITC; Ethidium Bromide; Ethidium homodimer-1 (EthD-1); Euchrysin; EukoLight; Europium (III) chloride; EYFP (Enhanced Yellow Fluorescent Protein); Fast Blue; FDA; FIF (Formaldehyde Induced Fluorescence); FITC; FITC Antibody; Flazo Orange; Fluo-3; Fluo-4; Fluorescein (FITC); Fluorescein Diacetate; Fluoro-Emerald; Fluoro-Gold (Hydroxystilbamidine); Fluor-Ruby; FluorX; FM 1-43™; FM 4-46; Fura Red™ (high pH); Fura Red™/Fluo-3; Fura-2, high calcium; Fura-2, low calcium; Fura-2/BCECF; Genacryl Brilliant Red B; Genacryl Brilliant Yellow 10GF; Genacryl Pink 3G; Genacryl Yellow 5GF; GeneBlazer (CCF2); GFP (S65T); GFP red shifted (rsGFP); GFP wild type, non-UV excitation (wtGFP); GFP wild type, UV excitation (wtGFP); GFPuv; Gloxalic Acid; Granular Blue; Haematoporphyrin; Hoechst 33258; Hoechst 33342; Hoechst 34580; HPTS; Hydroxycoumarin; Hydroxystilbamidine (FluoroGold); Hydroxytryptamine; Indo-1, high calcium; Indo-1, low calcium; Indodicarbocyanine (DiD); Indotricarbocyanine (DiR); Intrawhite Cf JC-1; JO-JO-1; JO-PRO-1; LaserPro; Laurodan; LDS 751; Leucophor PAF; Leucophor SF; Leucophor WS; Lissamine Rhodamine; Lissamine Rhodamine B; Calcein/Ethidium homodimer; LOLO-1; LO-PRO-1; Lucifer Yellow; Lyso Tracker Blue; Lyso Tracker Blue-White; Lyso Tracker Green; Lyso Tracker Red; Lyso Tracker Yellow; LysoSensor Blue; LysoSensor Green; LysoSensor Yellow/Blue; Mag Green; Magdala Red (Phloxin B); Mag-Fura Red; Mag-Fura-2; Mag-Fura-5; Mag-Indo-1; Magnesium Green; Magnesium Orange; Malachite Green; Marina Blue; Maxilon Brilliant Flavin 10 GFF; Maxilon Brilliant Flavin 8 GFF; Merocyanin; Methoxycoumarin; Mitotracker Green; Mitotracker Orange; Mitotracker Red; Mitramycin; Monobromobimane; Monobromobimane (mBBr-GSH); Monochlorobimane; MPS (Methyl Green Pyronine Stilbene); mStrawberry; NBD; NBD Amine; Nile Red; Nitrobenzoxadidole; Noradrenaline; Nuclear Fast Red; Nuclear Yellow; Nylosan Brilliant lavin EBG; Oregon Green™; Oregon Green™ 488; Oregon Green™ 500; Oregon Green™ 514; Pacific Blue; Pararosaniline (Feulgen); PBFI; PE-Cy5; PE-Cy7; PerCP; PerCP-Cy5.5; PE-TexasRed (Red 613); Phloxin B (Magdala Red); Phorwite AR; Phorwite BKL; Phorwite Rev; Phorwite RPA; Phosphine 3R; PhotoResist; Phycoerythrin B; Phycoerythrin R; PKH26 (Sigma); PKH67; PMIA; Pontochrome Blue Black; POPO-1; POPO-3; PO-PRO-1; PO-PRO-3; Primuline; Procion Yellow; Propidium lodid (PI); Pyrene; Pyronine; Pyronine B; Pyrozal Brilliant Flavin 7GF; QD400; QD425; QD450; QD500; QD520; QD525; QD530; QD535; QD540; QD545; QD560; QD565; QD570; QD580; QD585; QD590; QD600; QD605; QD610; QD620; QD625; QD630; QD650; QD655; QD705; QD800; QD1000; QSY 7; Quinacrine Mustard; Red 613 (PE-TexasRed); Resorufin; RFP; RH 414; Rhod-2; Rhodamine; Rhodamine 110; Rhodamine 123; Rhodamine 5 GLD; Rhodamine 6G; Rhodamine B; Rhodamine B 200; Rhodamine B extra; Rhodamine BB; Rhodamine BG; Rhodamine Green; Rhodamine Phallicidine;Rhodamine Phalloidine; Rhodamine Red; Rhodamine WT; Rose Bengal; R-phycocyanine; R-phycoerythrin; rsGFP (red shifted GFP (S65T)); S65A ; S65C; S65L; S65T; Sapphire GFP; SBFI; Serotonin; Sevron Brilliant Red 2B; Sevron Brilliant Red 4G; Sevron Brilliant Red B; Sevron Orange; Sevron Yellow L; sgGFPTM (super glow GFP; SITS (Primuline); SITS (Stilbene Isothiosulphonic Acid); SNAFL calcein; SNAFL-1; SNAFL-2; SNARF calcein; SNARF1; Sodium Green; SpectrumAqua; SpectrumGreen; SpectrumOrange; Spectrum Red; SPQ (6-methoxy-N-(3-sulfopropyl)quinolinium); Stilbene; Sulphorhodamine B can C; Sulphorhodamine G Extra; SYTO 11; SYTO 12; SYTO 13; SYTO 14; SYTO 15; SYTO 16; SYTO 17; SYTO 18; SYTO 20; SYTO 21; SYTO 22; SYTO 23; SYTO 24; SYTO 25; SYTO 40; SYTO 41; SYTO 42; SYTO 43; SYTO 44; SYTO 45; SYTO 59; SYTO 60; SYTO 61; SYTO 62; SYTO 63; SYTO 64; SYTO 80; SYTO 81; SYTO 82; SYTO 83; SYTO 84; SYTO 85; SYTOX Blue; SYTOX Green; SYTOX Orange; SYTOX Red; Tetracycline; Tetramethylrhodamine (TRITC); Texas Red™; Texas Red-X™ conjugate; Thiadicarbocyanine (DiSC3); Thiazine Red R; Thiazole Orange; Thioflavin 5; Thioflavin S; Thioflavin TCN; Thiolyte; Thiozole Orange; Tinopol CBS (Calcofluor White); TMR; TO-PRO-1; TO-PRO-3; TO-PRO-5; TOTO-1; TOTO-3; TriColor (PE-Cy5); TetramethylRodaminelsoThioCyanate; True Blue; TruRed; Tubulin Tracker™ Green; Ultralite; Uranine B; Uvitex SFC; wt GFP (wild type GFP); WW 781; X-Rhodamine; XRITC; Xylene Orange; Y66F; Y66H; Y66W; Yellow GFP (Yellow shifted); Green Fluorescent Protein; YFP (Yellow Fluorescent Protein); YO-PRO-1; YO-PRO-3; YOYO-1; YOYO-3; combinations and derivatives thereof; or the like. In one embodiment, the detection moiety, such as organic fluorophore, can have a molecular weight of at least 100 Daltons, including, without limitation, at least 1 kilo-Dalton (kD), at least 10 kD, at least 25 kD, at least 50 kD, at least 75 kD, at least 100 kD, at least 150 kD, at least 200 kD, at least 250 kD, at least 300 kD, at least 340 kD, at least 350 kD, at least 500 kD, and at least 750 kD. It should be noted that a nuclear stain, such as Sytox, can be used in combination with a quantum dot.

In the following descriptions, the terms “stain” or “label,” which are used interchangeably, are used to describe an affinity molecule bound to or interacted with a detection moiety. In one embodiment, the binding or interaction can be direct. Direct binding or interaction includes covalent or non-covalent interactions between the biomarker and the detection moiety (for example, via an intermediary molecule or a binding pair). In one embodiment, the binding or interaction can be indirect. Indirect binding or interaction includes a binding pair. For example, in one embodiment, the use of at least first and second complementary molecules form binding pairs. The first and second complementary molecules interact with one another. For example, the binding pairs can bind or interact via hydrophobic interactions, ionic interactions, hydrogen bonding interactions, non-covalent interactions, covalent interactions, affinity interactions, or the like. The binding pairs include, but are not limited to, immune-type binding-pairs, such as, antigen-antibody, antigen-antibody fragment, hapten-anti-hapten, or primary antibody-secondary antibody; non-immune-type binding-pairs, such as biotin-avidin, biotin-streptavidin, folic acid-folate binding protein, hormone-hormone receptor, lectin-specific carbohydrate, enzyme-enzyme, enzyme-substrate, enzyme-substrate analog, enzyme-pseudo-substrate (substrate analogs that cannot be catalyzed by the enzymatic activity), enzyme-cofactor, enzyme-modulator, enzyme-inhibitor, or vitamin B12-intrinsic factor. Other suitable examples of binding pairs include complementary nucleic acid fragments (including complementary nucleotides, oligonucleotides, or polynucleotides); Protein A-antibody; Protein G-antibody; nucleic acid-nucleic acid binding protein; polymeric linkers (e.g., polyethylene glycol); or polynucleotide-polynucleotide binding protein. The binding pairs can be included within or used as amplification techniques. Amplification techniques are also implemented to increase the number of detection moieties bound to or interacted with the biomarker to increase a signal. In one embodiment, when binding pairs are used, the stain can be pre-conjugated, such that, during a labeling, staining, or adding step, the affinity molecule is already bound to or interacted with a detection moiety when added to the sample. In one embodiment, when binding pairs are used, the stain can be conjugated in the sample, such that the labeling, staining, or adding step includes at least two sub-steps including introducing (in any desired or appropriate order) an affinity molecule-first binding molecule conjugate and a second binding pair molecule-detection moiety conjugate, wherein the first and second binding pair molecules are complementary and bind to or interact with each other.

Furthermore, “a plurality of stains” can be used to describe two or more stains in which the affinity molecules and/or the detection moieties are different. For example, anti-CK-CF647 is different than anti-EpCAM-CF647. As another example, anti-CK-CF647 is different than anti-CK-CF488.

In the following descriptions, the term “substrate” is used to describe a device into or upon which a sample or target analyte can placed. The substrate can be a microscope slide, a positively charged microscope slide, a coated microscope slide, a porous slide, a micro-well slide, a well plate, a coverslip, a cell microarray, or the like. The substrate can be composed be any appropriate material, including, but not limited to, glass, plastic, ceramic, metal, silica, combinations thereof, or the like. The substrate can be any optically acceptable material to allow for imaging (for example, glass, plastic, polymer, silica, combinations thereof, and the like).

In the following description, the term “expression level” is used to describe the amount of a biomarker present on or within a target analyte. Expression level is determined by calculating the mean expression level of the biomarker based on a plurality of the desired target analyte. Expression level may be categorized as “low,” “medium, ” or “high.” “Low expression” is more than 1 standard deviation below the mean. “Medium expression” is between −1 and +1 standard deviations from the mean (i.e. mean +/−1 standard deviation). “High expression” is more than 1 standard deviation above the mean. For example, a first target analyte has 2 EPCAM molecules; a second target analyte has 10 EPCAM molecules; a third target analyte has 18 EPCAM molecules; and a fourth target analyte has 30 EPCAM molecules. The mean is 15 and the standard deviation is 11.94. Therefore, “low expression” is less than 3.06 molecules; “medium expression” is 3.06-26.94 molecules; and “high expression” is more than 26.94 molecules. The first target analyte is “low”; the second and third target analytes are “medium”; and the fourth target analyte is “high.” Accordingly, and as discussed below, a reference moiety designed as a substitue for “medium expression” may have a “low” designation (i.e. less than 3.06 EPCAM molecules) or a “medium” designation (i.e. 3.06-26.94 EPCAM molecules). Consequently, the term “equal to or less than,” as it relates to “expression level,” specifies a comparison between categorization (i.e. “low” vs. “medium” vs. “high”) and not an absolute numbers comparison (i.e. 5 vs. 100 vs. 1000).

Alternatively, the expression level can be indicated by Fragments Per Kilobase Million (“FPKM”) or Transcripts Per Kilobase Million (“TPM”), which are metrics that normalize for sequencing depth and gene length when reporting results from RNA-seq. It should be noted that 0.5-10 FPKM or TPM is “low” expression; 11-1,000 FPKM or TPM is “medium” expression; and greater than 1,000 FPKM or TPM is “high” expression. Alternatively, the expression level can be measured by fluorescent or transmitted light imaging. For example, the mean fluorescent intensity (“MFI”) can be used to classify expression levels. MFI classification can be set or determined against a universal standard, within a given sample, across multiple samples, or can be set or determined in any appropriate manner based on operator or user preference. As a first example, a sample with a MFI of 100 can be classified as “low” expression, a MIF of 500 can be “medium” expression and a MFI of 1000 can be “high” expression.

An example method for labeling a biomarker on a target analyte is discussed. In one embodiment, a sample, such as blood, is obtained, such as by venipuncture. The sample is suspected of including at least one target analyte. Suitable devices, systems, and/or methods of sample collection and/or processing can include those described in one or more of the following U.S. patents and published applications, each of which is hereby incorporated by reference in its entirety: 7,074,577; 7,220,593; 7,329,534; 7,358,095; 7,629,176; 7,915,029; 7,919,049; 8,012,742; 9,039,999; 9,217,697; 9,492,819; 9,513,291; 9,533,303; 9,539,570; 9,541,481; 9,625,360; 2014/0161688; 2017/0014819; 2017/0059552; 2017/0074759. Suitable devices, systems, and/or methods for target analyte retrieval, isolation, or picking can include those described in one or more of the following U.S. patents and published applications, each of which is hereby incorporated by reference in its entirety: 9,222,953; 9,227,188; 9,440,234; 9,519,002; 9,810,605; 2017/0219463; 2017/0276575.

The sample is then dispensed onto at least one slide 202. In one embodiment, the sample is distributed across the slide 202, such as by, for example, spreading, wetting, nutating, centrifuging, and the like. In one embodiment, the sample can undergo additional processing, such as, for example, fixation, permeabilization, re-suspension, and the like.

The sample then undergoes staining. At least one stain is added to the sample for labeling, such as by an autostainer or manually by an operator. In one embodiment, the at least one target analyte is stained. In one embodiment, at least one non-target analyte or non-target material is stained. In one embodiment, the at least one target analyte and the at least one non-target analyte or materials are stained. In one embodiment, multiplexing is performed (i.e., multiple biomarkers are labeled in a single round). In one embodiment, sequential or repeated labeling is performed (i.e., one or more biomarkers are labeled in a plurality of rounds).

After staining, the sample can be imaged, whereby the stained sample is illuminated with one or more wavelengths of excitation light, such as white, infrared, red, blue, green, and/or ultraviolet, from a light source, such as a laser or a light-emitting diode. The imaging can be done with a microscope, such as a fluorescent microscope, a scanner, or any other appropriate imaging system or modality. In one embodiment, imaging can be performed in a system in which a detection moiety, when imaged, can provide a signal across a spectrum, including, without limitation, brightfield and/or darkfield illumination, fluorescence, and the like. The images formed can be overlaid when a plurality of detection moieties are used. Emission, reflection, diffraction, scatter, and combinations thereof are used for detection/imaging. The images can be analyzed to classify/characterize, detect, enumerate, and/or locate the target analyte, such as when it is desirous to retrieve or pick the target analyte. Imaging can be performed in a tube, on a microscope slide, or in any appropriate vessel or substrate for imaging.

The methods can be performed by at least one of an imaging microscope or a scanner. The methods described can be used in a system in which a detection moiety, when imaged, can provide a signal across a spectrum, including, without limitation, at least one of brightfield and/or darkfield illumination, phase contrast, differential interference contrast, fluorescence, and Hoffman modulation contrast imaging or detection.

### Reference Section

A reference section is an area or location of a substrate comprising one or more reference moieties. For example, a single cell line can be represented by a single reference moiety in a reference section. As another example, two cell lines can be represented by two or more reference moieties in a reference section. In one embodiment, the one or more reference moieties can be provided in any appropriate pattern, formation, arrangement, or configuration. In one embodiment, the one or more reference moieties can be provided in any random pattern, formation, or configuration, whether as part of a reference section or as individual reference moieties. The one or more reference moieties comprise one or more distinguishable features. In one embodiment, a plurality of reference moieties representing different cell lines has the same distinguishable feature relative to the sample or target analyte. In one embodiment, a plurality of reference moieties representing different cell lines has different distinguishable features relative to the sample or target analyte and relative to each other. In one embodiment, two or more of the reference moieties have the same type of distinguishable feature at varying levels. For example, a first reference moiety can have a high expression level of a first biomarker, a second reference moiety can have a medium expression level of the first biomarker, a third reference moiety can have a low expression level of the first biomarker, and a fourth reference moiety can have no expression of the first biomarker.

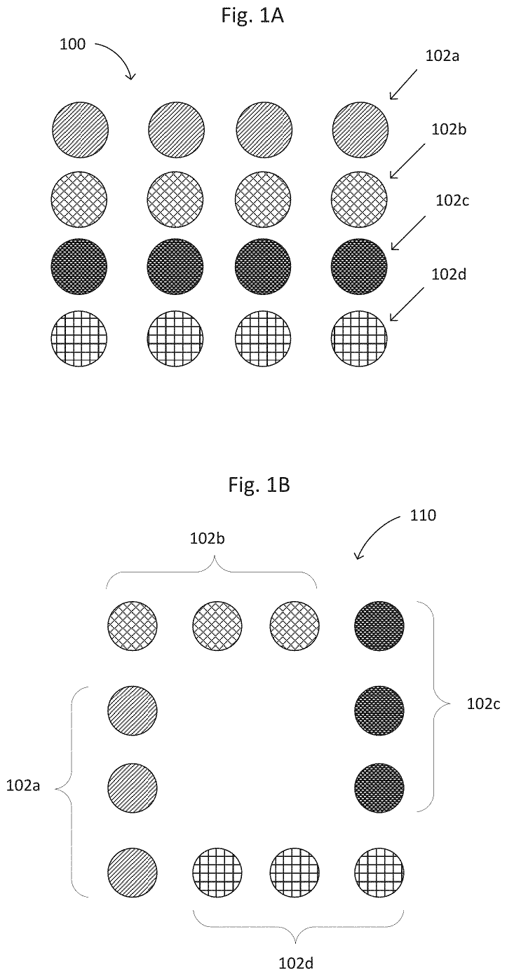

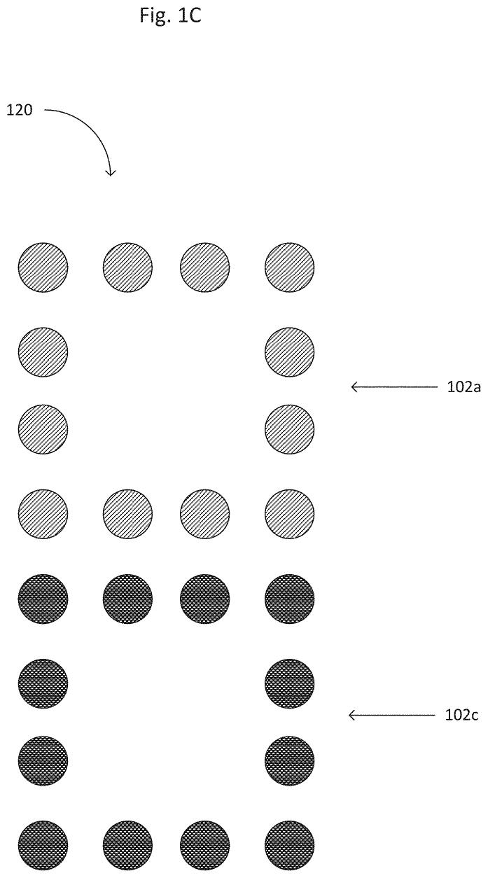

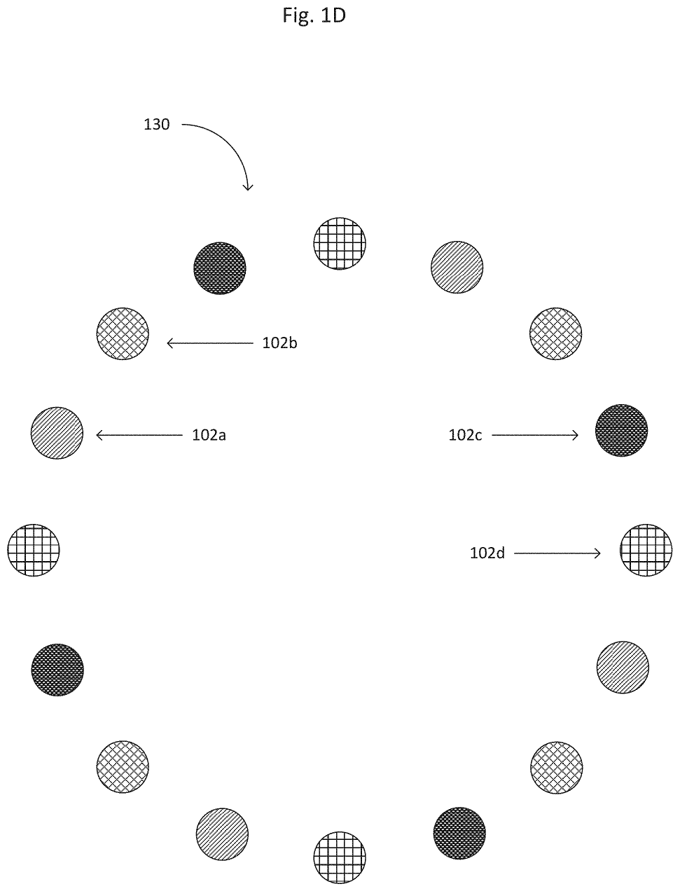

FIG. 1A shows a magnified view of a reference section 100. The reference section 100 comprises at least one reference line 102a. In one embodiment, the reference section 100 (i.e., when taken as a whole) comprises a distinguishable feature (e.g., pattern, formation, location, combinations thereof, and the like). In one embodiment, the at least one reference line 102a comprises a distinguishable feature (e.g., size, shape, autofluorescence, light modality, pre-labeled, labeled in one channel not used by the sample or target analyte, labeled in the channel used by the sample or target analyte, combinations thereof, and the like). In one embodiment, the reference section 100 (i.e., when taken as a whole) comprises a distinguishable feature and the at least one reference line 102a comprises another distinguishable feature. For example, the section 100 can be placed in a given location and/or can have a distinct shape (e.g., square or circular) and the at least one reference line 102a of the reference section 100 is pre-labeled in a channel not used by the sample or target analyte and is sized to be larger than the target analytes of the sample.

The reference section 100 is formed from the reference lines 102a-102d being aligned in rows, columns, or diagonals within the reference section 100. In one embodiment, the reference section 100 comprises two or more reference lines 102a-102d. When two or more reference lines 102a-102d are used, at least two different reference lines 102a-102d can represent different cell lines. For example, first reference lines 102a can be polymeric beads with at least one biomarker of a JEG3 cell; and second reference moieties 102b can be polymeric beads with at least one biomarker of a SKBR-3 cell. Therefore, the first reference lines 102a are representative of JEG3 cells; and the second reference moieties are representative of SKBR-3 cells. The biomarkers used on the first and second reference lines 102a, 102b can be generally exclusive to the cell lines being represented (i.e., only found on those types of cells), can be exclusive to the cell line being represented relative to the other cell lines being represented (i.e., only found on that type of cell relative to the other cell lines being represented in the reference section 100), or a combination thereof. As another example, first reference lines 102a can be polymeric beads with at least one biomarker of a JEG3 cell; and second reference moieties 102b can be cells (such as from a cell culture) with at least one biomarker of a SKBR-3 cell. Therefore, the first reference lines 102a are representative of JEG3 cells; and the second reference moieties are representative of SKBR-3 cells. As another example, first reference lines 102a can be polymeric beads with at least one first biomarker of a JEG3 cell; and second reference moieties 102b can be polymeric beads with at least one second biomarker of a JEG3 cell. Therefore, the first and second reference lines 102a, 102b are representative of different biomarkers of JEG3 cells.

Though four reference lines 102a-102d are shown to represent four cell lines, any number of reference moieties can be used to represent any number of cell lines. For example, the reference section can comprise at least 1, 2, 3, 4, 5, 6, 7, 8, 9, 10, 12, 16, 20, 24, 30, 40, 50, 60, 70, 75, 80, 90, 99, or 100 reference moieties representing at least 1, 2, 3, 4, 5, 6, 7, 8, 9, 10, 12, 16, 20, 24, 30, 40, 50, 60, 70, 75, 80, 90, 99, or 100 cell lines. In other words, 100 reference moieties within a reference section can represent a single cell line (i.e., 100 reference moieties represent 1 cell line); or, 100 cell lines can each be represented by 1 reference moiety (i.e., 1 of 100 reference moieties represents 1 of 100 cell lines).

Furthermore, the area of the surface of the substrate 102 occupied by the reference sections 100 are equal to an M×N matrix, where M is the number of reference lines 102a-102d within the reference section 100, and where N is the number of cells for the reference line 102a-102d having the most cells within the reference section 100. For example, a first reference section comprises 4 reference moieties with each reference moiety having 4 cells and has an area of 4×4. As another example, a second reference section comprises 3 reference moieties with each reference moiety having 4 cells and has an area of 3×4. As another example, a third reference section comprises 3 reference moieties with 1 reference moiety having 3 cells, 1 reference moiety have 4 cells, and 1 reference moieties having 5 cells. The area of the third reference section is 3×5 (3 reference moieties with a maximum of 5 cells). In one embodiment, all of the reference sections have the same M×N matrix dimensions. In one embodiment, at least two of the reference sections have different matrix dimensions, such that one has M×N dimensions and another has P×Q matrix dimensions (where P is the number of reference lines 102a-102d within the reference section 100, and where Q is the number of cells for the reference line 102a-102d having the most cells within the reference section 100).

In one embodiment, each of the reference sections 100 has the same number of reference lines (the reference lines can have the same number of reference moieties or different numbers of reference moieties). In one embodiment, two or more reference sections have different numbers of reference lines (the reference lines can have the same number of reference moieties or different numbers of reference moieties). In one embodiment, the reference lines can have varying arrangements across a plurality of reference sections, thereby creating uniquely identifiable reference sections having the same staining characteristics. For example, a first reference section can have a reference line arrangement of A-B-C-D from top down; a second reference section can have a reference line arrangement of D-C-B-A from top down; a third reference section can have a reference line arrangement of B-C-D-A from top down; and so on. Furthermore, each of the reference sections 100 can have the same reference lines; or, two or more reference sections 100 can have one or more different reference lines.

FIG. 1B shows a magnified view of a reference section 110. The reference section 110 is similar to the reference section 100, except that the reference section 110 is a square comprising two or more reference lines 102a-102d. FIG. 1C shows a magnified view of a reference section 120. The reference section 120 is similar to the reference section 110, except that the reference section 120 is two or more squares, the first square comprising the first reference line 102a and the second square comprising third reference line 102c. FIG. 1D shows a magnified view of a reference section 130. The reference section 130 is similar to the reference section 100, except that the reference section 130 is a circle comprising alternative reference lines 102a-102d. However, the pattern or formation is only an example and not intended to be so limited as the examples. The pattern or formation can include one or more circle, triangle, square, rectangle, parallelogram, rhombus, pentagon, combinations thereof, or the like.

Furthermore, the reference section can include random placement of one or more reference moieties.

### Reference Substrate

For the sake of convenience, the reference substrate shall be referred to as a slide or reference slide. However, as noted above, the reference substrate is not intended to be so limited.

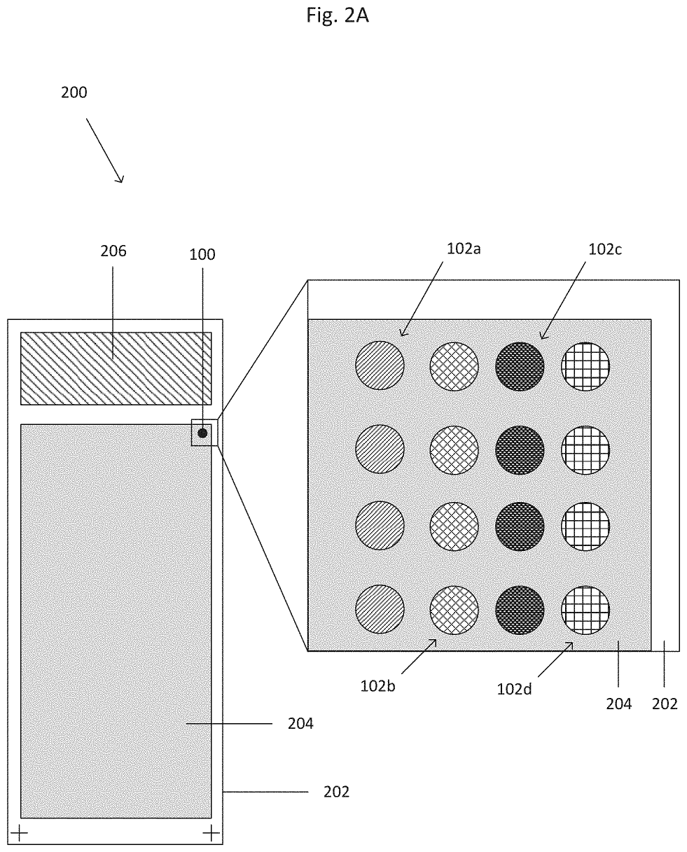

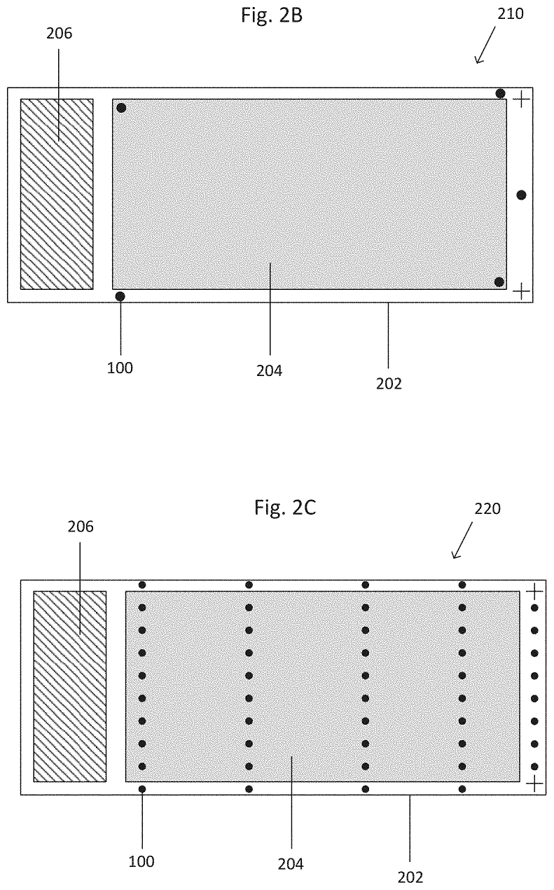

FIG. 2A shows a reference substrate 200. The reference substrate 200 comprises a slide 202 comprising at least one reference section 100. The reference section 100 occupies an area of the surface of the slide 202. The reference substrate 200 further comprises a sample area 204—an area into which a sample can be located when added to or spread across the slide 202. The reference substrate 200 can also include a printed area206 to identify specific slides.

In one embodiment, the sample area 204 can partially or completely cover the reference section 100. Therefore, the sample area 204 and the reference section 100 overlap and share a portion of the surface of the slide 202. For example, when the reference section 100 comprises reference moieties having varying expression levels, the high, medium, and low expressers can be in the sample area 204. In one embodiment, the sample area 204 touches, but does not overlap or cover the reference section 100. Therefore, the sample area 204 and the reference section abut each other. In one embodiment, the sample area 204 and the reference section 100 do not touch or abut each other, such that there is a gap between the other edges of the sample area 204 and the reference section 100.

FIGS. 2B-2C show reference substrates 210, 220 comprising a plurality of reference sections 100 with different layouts or placements of the plurality of reference sections. In other words, each reference section 100 occupies a different portion of the surface of the slide 202.

Though reference section 100 is shown to be duplicated multiple times on the slide 202, the disclosure is not intended to be so limiting. In one embodiment, such as when a plurality of reference sections is used, the reference sections can be the same. For example, each reference section has the same number of reference moieties representing the same cell lines (however, the distinguishable features can be the same or different between reference moieties and/or reference sections). In one embodiment, such as when a plurality of reference sections is used, at least two reference sections can be the same. In one embodiment, such as when a plurality of reference sections is used, each reference section can be unique, thereby having any number of reference moieties representing any number of cell lines and having any type or number of distinguishable features (i.e., no two reference sections are the same). For example, one reference section can have a single reference moiety representing a first cell line; another reference section can have a single reference moiety representing a second cell line; another reference section can have two reference moieties, such that each reference moiety represents the first cell line, the second cell line, a third cell, or a fourth cell line; each reference section may have a unique arrangement of reference moieties, and so on.

The reference section 100 or plurality of reference sections 100 are placed on the slide 202 in any desired location. For example, the plurality of reference sections 100 can be in a straight line (e.g., a row, a column, or a diagonal), can be staggered, or can be in a plurality of straight lines (e.g., rows, columns, diagonals). As another example, the one or more reference sections 100 can be placed in one or more corners of the slide 202; the one or more reference sections 100 can be placed no more than 10 cm (for example, up to 1 mm, 2 mm, 3 mm, 4 mm, 5 mm, 10 mm, 25 mm, 50 mm, or 75 mm) in any direction from one or more corners of the slide 202; one or more reference sections 100 can be placed in the center of the slide 202; one or more reference sections 100 can be placed no more than 10 cm (for example, up to 1 mm, 2 mm, 3 mm, 4 mm, 5 mm, 10 mm, 25 mm, 50 mm, or 75 mm) from the center of the substrate; or, one or more reference sections 100 can be placed no more than 10 cm (for example, up to 1 mm, 2 mm, 3 mm, 4 mm, 5 mm, 10 mm, 25 mm, 50 mm, or 75 mm) from one or more edges of the surface of the substrate 200. In other words, the one or more reference sections 100 can placed at any desired locations forming any desired configuration, so as to, for example, enhance and/or ensure validation of a process, imaging, staining, combinations thereof, or the like. As another example, a plurality of reference sections 100 can be inside the sample area 204 and a plurality of reference sections can be outside of the sample area 204.

The reference sections 100 are applied to the surface of the slide 202 using one or more methods. Though multiple embodiments and examples are discussed, the embodiments and examples can be combined or modified when it is desirous to do so. In one embodiment, the reference lines 102a-102d are mixed with a gel or coating and applied to the surface of the slide 202. In one embodiment, the reference lines 102a-102d are embedded within the slide 202.

In one embodiment, the reference lines 102a-102d are individually deposited on the surface of the slide 202 (e.g., the cells of the reference lines 102a-102d are printed on the surface of the slide 202; deposited via a pipet; etc.), such as with a single object dispensing apparatus. Depositing the reference lines 102a-102d individually (e.g., printing; pipet deposition; etc.) permits the user or operator to form the reference sections 100 at specific locations on the slide 202. Additionally, depositing the reference lines 102a-102d individually permits the user or operator to form the reference section 100 into specific shapes, orientations, and/or configurations. For example, it may be desirous to have four reference sections 100, each in or within 10 cm (for example, up to 1 mm, 2 mm, 3 mm, 4 mm, 5 mm, 10 mm, 25 mm, 50 mm, or 75 mm) of a corner of the substrate to ensure at least one of uniform staining or imaging. Furthermore, depositing the reference lines 102a-102d individually permits the user or operator to form the reference sections 100 in known locations, thereby being able to determine whether the signal obtained during imaging is from the reference lines 102a-102d or from the sample. Depositing the reference lines 102a-102d individually provides the ability to form unique reference line arrangements for each reference section 100 and allows reference section identification during processing.

The individual reference lines 102a-102d, for example, can be dispensed with an automated apparatus or a manual apparatus. Furthermore, the individual reference lines 102a-102d can be deposited in any desired order. For example, all of the reference lines 102a-102d can be dispensed at the desired locations on the slide 202 before dispensing the next batch of reference lines 102a-102d (i.e., reference line 102a is dispensed at the desired locations on the slide 202, then reference moiety 102b is dispensed at the desired locations on the slide 202, and so on). In one embodiment, each reference line 102a-102d is added to the reference section 100 before adding the reference line 102a-102d to another reference section 100 (i.e., reference lines 102a-102d are dispensed within a first reference section, then reference lines 102a-102d are dispensed within a second reference section, and so on.

The reference lines 102a-102d can be cured or adhered to the surface of the slide 202. For example, the reference lines 102a-102d are adhered to a surface of the slide 202, such as by an adhesion reagent (for example, a transfer fluid, a fixative, combinations thereof, and the like). In one embodiment, the reference lines 102a-102d are suspended in the adhesion reagent prior to dispensing the reference lines 102a-102d onto the surface of the slide 202, such that a portion of the adhesion reagent is dispensed with one or more of the reference lines 102a-102d. In one embodiment, the adhesion reagent is applied to the surface of the slide 202 before or after the reference lines 102a-102d are dispensed. Suitable adhesion reagents can include those described in one or more of the following U.S. patents and published applications, each of which is hereby incorporated by reference in its entirety: 10,101,248; 10,101,247, 2017/0322125; and 2018/0364136.

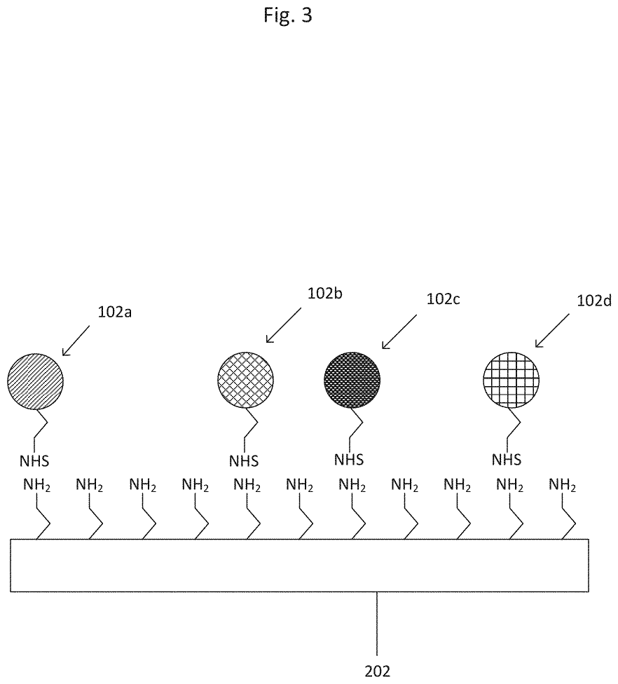

Furthermore, “surface” of the slide 202 is not intended to be so limited to an exterior face of the slide 202. The “surface” of the slide 202 can include, for example, any substance, chemical, reagent, combinations thereof, and the like (for example, silane based or other surface chemistry or processing, any functionalization, coating, reagent, or gel) applied to the exterior face thereby forming an outermost layer of the slide 202. For example, as shown in FIG. 3, the slide 202 can have a functionalized surface to bind the reference lines 102a-102d to the surface. The slide surface can be functionalized with one or more modifications, including, for example, amine, amino, carboxy, epoxy, aldehyde, activated amino, thiol, azide, or the like. The reference lines 102a-102d can be functionalized with corresponding modifications to react with the modifications of the slide surface.

The reference lines 102a-102d can be labeled before being dispensed on the slide 202 (i.e., pre-labeled), can be labeled after being dispensed on the slide 202 but before the sample is added, or can be labeled during the same labeling process as the sample. In one embodiment, when two or more reference lines 102a-102d are used, no two reference lines 102a-102d are labeled with stains comprising detection moieties having the same emission wavelength. In one embodiment, when two or more reference lines 102a-102d are used, two or more reference lines 102a-102d are labeled with stains comprising detection moieties having the same emission wavelength.

The reference lines 102a-102d are selected to include or express one or more biomarkers to be labeled within the sample, a target analyte and/or a non-target analyte. The reference lines 102a-102d can be the same as the target analyte and/or the non-target analyte. For example, the reference lines 102a-102d can include or represent at least one of 5637, 22Rv1, 4T1-1uc2, 5TGM1-Luc, 769-P, 786-0, 786-0-Luc-Neo (rescued), A20, A2058, A20-Luc2-Puro, A2780, A2780-Luc, A375, A-431, A-498, A549, A549-Luc-C8, A-673, AB-1, ACHN, ARH-77, B16, B16-F10, B16-F10-Luc2, B16-F10-Luc-G5, BeWo, B-JAB, BNL 1ME A.7R.1, BNL 1ME A.7R.1-Luc-mCh-Puro, BT142, BT-20, BT-474, Bx-PC-3, BxPC-3-Luc2, C1498, C1498-Luc-mCh-Puro, C26, C2BBe1, C51, Caco-2, Caki-1, CAL 27, Calu-1, Calu-3, Calu-6, Capan-1, Capan-2, CCRF-CEM, COLO 205, COLO 205-Luc #2, COLO 829, COS-7, CT26.WT, CWR-22-R, D54-Luc, Daudi, Daudi-Luc-mCh-Puro, DB, DB/M2, DBTRG (tumor), DBTRG-05MG, DLD-1, DMS 114, DND-41-Luc-mCh-Puro, DU 145, DU 145-Luc, E.G7-OVA, E0771, EBC-1, EMT-6, EOL-1, FaDu, Farage, G-361, GIST-T1, GL261, GL261-Luc2, Gli36-DsRed-R-Luc (rescued), GRANTA-519, HCC2998, HCC70, HCC827, HCC827-Luc-mCh-Puro, HCT-116, HCT-116-Luc, HCT-15, HCT-8, HEK 293, HEK 293-Luc-mCh-Puro, HEKn (Human Epithelial Keratinocytes), HEL, HEL 92.1.7, HEL 92.1.7-Luc-Neo, HeLa, HEL-Luc-Neo, Hep 3B2.1-7, Hep G2, Hep55.1c, Hepa 1-6, Hepa 1-6-Luc-mCh-Puro, HL-60, Hs 578Bst, Hs 578T, Hs 895.Sk, Hs 895.T, HT, HT-1080, HT-1376, HT-29, HT-29-Luc, HuT 78, IDB, ID8-Luc-mCh-Puro, IGROV1, IGROV1-Luc-Mch-Puro, J558, J774A.1, J82, JEG-3, JJN-3-Luc, Jurkat, Jurkat-Clone E6-1, K-562, K-562-Luc2, KARPAS 299, Kasumi-1, Kasumi-3, Kasumi-3-Luc-mCh-Puro, KB, KG-1-Luc-mCh-Puro, KP4, L1210, LL, LL/2, LL/2-Luc-M38, LN-18, LN-229, LN-827(pMMP-LucNeo), LnCap clone FGC, LoVo, LoVo-6-Luc1, LOX-IMVI, LS 174T, LS411N, M059K, M14, MB-1, MB49, MBT-2, MC38, MCF 10A, MCF-7, MCF7-Luc-mCh-Puro, MDA-MB-231, MDA-MB-231-2LMP, MDA-MB-231-Luc-D3H1, MDA-MB-231-Luc-D3H2, MDA-MB-231-Luc-D3H2LN, MDA-MB-231-Luc-D3H3, MDA-MB-361, MDA-MB-435S, MDA-MB-453, MDA-MB-468, MG-63, MIA PaCa-2, MIA PaCa-2-Luc, MKL-1, MM.1S (pMMP-Luc-Neo), MMTV-PyMT, M-NFS-60, MOLM-13, MOLT-4, MOLT-4-Luc-MCh-Puro, MV-4-11, MV-4-11-FUW-Luc-mCh-Puro, MX-1, MX-1-Luc, NALM6, NALM6-Luc-MCh-Puro, NAMALWA, NCI-H125, NCI-H125-Luc, NCI-H1299, NCI-H1650, NCI-H1703, NCI-H1703-Luc-mCh-Puro, NCI-H1975, NCI-H1975-Luc, NCI-H2110, NCI-H2122, NCI-H23, NCI-H292, NCI-H295R, NCI-H3122, NCI-H322M, NCI-H441, NCI-H446, NCI-H460, NCI-H460-Luc2, NCI-H508, NCI-H522, NCI-H596, NCI-H69, NCI-H82, NCI-H929, NCI-H929-Luc-mCh-Puro, NCI-N87, Neuro-2a, NHDF (normal human dermal fibroblasts), NIH:OVCAR-3, NIH:OVCAR-3-Luc-mCh-Puro, NK-92MI, NOM0-1, NUGC-4, OCI-Ly1 LN, OCI-Ly19-Luc-Neo, OCI-Ly3-Luc-mCh-Puro, OCI-Ly7-Luc-mCh-Puro (rescued), OCI-Ly7-Luc-Neo, OCM-1, OCM-1-Luc-mCh-Puro, 0E33, OPM-2, OV-90, OVCAR-4, OVCAR-5, OVCAR-5 -Luc-mCh-Puro, OVCAR-8, OVCAR-8-Luc-mCh-Puro, P388, P388D1, P815, Pan02, Pan03, PANC-1, PANC-1-Luc, PA-NUT, PC-3, PC-3-Luc, PC-3M-Luc-C6, PC-9, Pfeiffer, Raji, Raji-Luc, Ramos, Ramos-Luc, RAW 264.7, Reh, Reh (pMMP-Luc-Neo), Renca, RIF-1, RL, RPMI 8226, RS4;11, Saos-2, SF-295, SF-539, SF-767, SHP-77, SJSA-1, SK-BR-3, SK-LMS-1, SK-MEL-28, SK-MEL-28-Luc-mCh-Puro, SK-MEL-5, SK-MES-1, SK-N-AS, SK-N-FI, SK-N-SH, SK-OV-3, SKOV-3-luc-D3, SNB-19, SNU-5, SU-86.86, SU-DHL-10, SU-DHL-10-LN-High, SU-DHL-16, SU-DHL-4-Luc-mCh-Puro, SU-DHL-6, SU-DHL-6-Luc-mCh-Puro, SU-DHL-8, SW 1990, SW 780, SW 872, SW-480, SW-620, T24, T24-Luc-Neo, T24P, T47D, TE 353.Sk, TE 354.T, TF-1a, TF-1a-Luc-Neo, THP-1, TK-10, TMD8, Toledo-Luc-Neo, TT, U251, U251-Luc-mCh-Puro, U266B1, U-87 MG, U-87 MG-Luc, UACC-62, UISO-BCA-1, VCaP, WM-115, WM-266-4, WSU-DLCL2, WSU-FSCCL, YAC-1, and ZR-75-1.

### Example Reference Slides

In a first example, a reference section comprises reference moieties having varying expression levels: a first reference moiety has a high expression level of a first biomarker, a second reference moiety as a medium expression level of the first biomarker, a third reference moiety has a low expression level of the first biomarker, and a fourth reference has no expression of the first biomarker. The reference moieties are beads (for example, polymeric, glass, ceramic, magnetic, metallic, or the like) which are capable of being imaged in brightfield (i.e., the distinguishable feature). The biomarker is attached to an outer surface of the beads. The high, medium, and low expressers are located in the sample area. The biomarkers of the varying expressers can be pre-labeled with a fluorescent detection moiety or can be labeled with a fluorescent detection moiety simultaneously with the sample. The fluorescent detection moiety of the expressers can be the same or different than the fluorescent detection moiety of the sample for the given biomarker.

In another example, a reference section comprises BT-474 and 22RV1 cells.

In yet another example, a reference section comprises proteins corresponding to one or more of the following biomarkers: EpCAM, CK, CD45, Her2, PDL-1, and ARv7. In another example, the reference section comprises a protein, an antibody, haptens, a peptide, an aptamer, an oligonucleotide, a polynucleotide, or other suitable reference moiety, such as which may deposited on their own, in a droplet, or any appropriate transfer component.

In another example, the reference moieties are labeled (i.e., pre-labeled or labeled after being added to the slide) with a detection moiety having a first emission wavelength and reference sections are located every 500 micrometers across the surface of the slide. Prior to adding the sample, the slide is imaged and a mean fluorescent intensity for the reference moieties is obtained. After adding the sample, labeling the sample with a detection moiety having a second emission wavelength, and imaging, the mean fluorescent intensity of the reference moieties can be subtracted from any images to remove any undesired signal caused by the reference moieties.

In another example, the reference moieties are labeled (i.e., pre-labeled or labeled after being added to the slide) with one or more detection moieties having different peak emission wavelengths. After the sample has been processed and added to the slide, the slide is imaged and a mean fluorescent intensity for the reference moieties is obtained. The mean fluorescent intensity of the reference moieties can be used to adjust the imaging parameters to bring the mean fluorescent intensity of the reference to a desired level or standard. This accounts for system-to-system and process-to-process variability.

In another example, one or more reference moieties are labeled (i.e., pre-labeled or labeled after being added to the slide) with one or more detection moieties having different peak emission wavelengths, wherein each reference moiety includes one or more detection moieties having the same peak emission wavelength. In other words, multiple reference moieties and multiple detection moieties can be used, though each reference moiety has detection moieties which only emit the same peak emission wavelength. The slide is imaged, whether before or after the sample is added, and the spectral response of the respective detection moieties obtained. This accounts for spectral shifts of the various detection moieties during imaging relative to the detection moieties' expected or anticipated emissions.

In yet another example, the reference moieties are used as fiducials or references for image stitching, image overlay, region of interest recording, and/or target material characterization. For example, the reference moieties can have a set size. The target material size can be referenced relative to reference moieties.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention. Additionally, though “first” and “second” are used, the terms are not intended to limit various features/elements to only one or two. Rather, three (i.e., third), four (i.e., fourth), or more may be included or used where appropriate or desirous to do so.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc.

Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

Though certain examples and embodiments are discussed individually, steps or components can be used together and/or across different embodiments, where it is desirous and/or advantageous to do so. The example and embodiments are intended to be illustrative so as to highlight certain specific aspects or combinations without being so limiting.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

What is claimed is:

1. A reference slide comprising:
at least one reference section comprising M reference lines, wherein each reference line expresses or represents a different biomarker, and wherein each reference line comprises N reference moieties expressing or representing different levels of the biomarker expressed or represented by each reference line,
wherein M is greater than or equal to 2, and
wherein N is greater than or equal to 2.

2. The reference slide of claim 1, wherein the at least one reference section is a M×N matrix, wherein M is the number of reference lines, and wherein N is number of reference moieties used per reference line.

3. The reference slide of claim 1, wherein the at least one reference section is at a known location on the reference slide.

4. The reference slide of claim 1, wherein the biomarker expressed or represented by each reference line is suspected of being in a sample.

5. The reference slide of claim 1, wherein the biomarker expressed or represented by the M reference lines is labeled with at least one detection moiety.

6. The reference slide of claim 1, wherein the reference moieties are beads.

7. The reference slide of claim 6, wherein the beads are polymeric or glass.

8. The reference slide of claim 1, wherein the reference moieties are at least one of cells and proteins.

9. The reference slide of claim 1, wherein the reference moieties are adhered to a surface of the reference slide via an adherent solution.

10. The reference slide of claim 1, wherein the reference moieties are mixed within a gel or coating applied to a surface of the reference slide.

11. The reference slide of claim 1, wherein the reference moieties are embedded within the reference slide.

12. The reference slide of claim 1, further comprising at least one reference section comprising Y reference lines, wherein each reference line expresses or represents a different biomarker, wherein each reference line comprises Z reference moieties expressing or representing different levels of the biomarker of each reference line,
wherein Y is greater than or equal to 1, and
wherein Z is greater than or equal to 2.

13. The reference slide of claim 12, wherein the at least one reference section comprising Y reference lines and the at least one reference section comprising M reference lines have at least one common reference line.

14. The reference slide of claim 12, wherein the at least one reference section comprising Y reference lines and the at least one reference section comprising M reference lines do not have any common reference line.

15. The reference slide of claim 1, wherein the reference moieties of one of the at least one M reference lines comprises a first distinguishable feature relative to a sample.

16. The reference slide of claim 15, wherein the reference moieties of another of the at least one M reference lines comprises a second distinguishable feature relative to a sample.

17. The reference slide of claim 16, wherein the first and second distinguishable features are the same.

18. The reference slide of claim 16, wherein the first and second distinguishable features are different and are distinguishable from each other.

19. A method for making a reference slide, the method comprising:
adding M reference lines to the reference slide, wherein each of the M reference lines expresses or represents a different biomarker, wherein each of the M reference lines comprises N reference moieties expressing or representing different levels of the biomarker expressed or represented by each reference line,
wherein M is greater than or equal to 2, and
wherein N is greater than or equal to 2.

20. The method of claim 19, wherein adding M reference lines comprises adding a M×N matrix, wherein M is the number of reference lines, and wherein N is number of reference moieties used per reference line.
